(19) United States
(12) Patent Application Publication
(10) Pub. No.: US 2026/0261106 A1
(43) Pub. Date: Sep. 3, 2026

(54) HOLDING DEVICE FOR CABLES

(71) Applicant: BIZLINK INDUSTRY GERMANY GMBH, Roth (DE)

(72) Inventors: Manish PATEL, KITCHENER (CA); Michael AYOUB, KITCHENER (CA)

(21) Appl. No.: 19/162,079

(22) PCT Filed: Feb. 27, 2024
(86) PCT No.: PCT/EP2024/054938

§ 371 Date: Sep. 4, 2025

(30) Foreign Application Priority Data
Mar. 16, 2023 (DE) 10 2023 106 636.6

(51) Int. Cl. H02G 3/32; F16L 3/10; F16L 3/22

(52) U.S. Cl. CPC H02G 3/32; F16L 3/10; F16L 3/22

(57) ABSTRACT

A holding device for cables is disclosed that can include at least two holding elements arranged relative to one another and stacked one on top of the other along a longitudinal axis. Each of the at least two holding elements has a holding section that extends at least substantially transversely to the stack longitudinal axis and at least one spacer section that extends from the holding section in a side region of the holding section at least substantially along the stack longitudinal axis. The holding section and the at least one spacer section can be formed in one piece. The at least two holding elements are arranged relative to one another such that the at least one spacer section of a first of the at least two holding elements and the holding section of a second of the at least two holding elements are in direct contact with one another.

The invention relates in general to a holding device for cables, in particular ribbon cables.

Ribbon cables for highly flexible applications are frequently fixed by means of a clamp in order to be able to fasten the ribbon cables as effectively and securely as possible. If a number of ribbon cables are to be used together in a single installation, such clamps are usually stacked and thereby form a clamp arrangement with a number of clamps.

In the state of the art, an upper plate and a lower plate are usually held spaced by separate spacers to create a clamping space and are connected to one another by way of the spacers. The clamping space serves to clamp the ribbon cable used. A structure of this kind, however, produces a relatively high construction height, which is disadvantageous on account of the small space available in many applications.

Such a clamp and a clamp arrangement of this kind with a number of clamps stacked one on top of the other is known, for example, from DE 11 2017 000 173 T5. In this, an upper clamp and a lower clamp are described, which are connected to one another by way of connection elements in order to set a coupling height between upper clamp and lower clamp.

WO 2021/209819 A2 likewise describes an end fastening device, in which two plate connectors provided as separate components are provided in order to grip and to connect two clamping plates respectively in pairs at one of two lateral end regions respectively of the clamping plates.

In view of said state of the art, a requirement exists, therefore, to provide a holding device for cables, in particular ribbon cables, which has a minimal space requirement that is in particular reduced compared with the state of the art.

According to a first aspect of the invention, a holding device for cables, in particular ribbon cables, is provided. The holding device has at least two holding elements. The at least two holding elements are arranged relative to one another and stacked one on top of the other along a stack longitudinal axis. Each of the at least two holding elements has a holding section and at least one spacer section. The holding section extends at least substantially transversely to the stack longitudinal axis. For example, the holding section extends at least substantially perpendicularly to the stack longitudinal axis. The at least one spacer section extends in or from a side region of the holding section at least substantially along the stack longitudinal axis from the holding section. For example, the at least one spacer section extends in or from a side region of the holding section at least substantially perpendicularly to the holding section. Regardless of the exact configuration, arrangement and/or extension of the holding section and of the at least one spacer section relative to one another, the holding section and the at least one spacer section are formed in one piece with one another.

The at least two holding elements are arranged relative to one another along the stack longitudinal axis such that the at least one spacer section of a first of the at least two holding elements and the holding section of a second of the at least two holding elements are directly in contact with one another. On account of the direct contact, no intermediate elements such as intermediate plates, for example, are present. This reduces the space requirement. Said arrangement is in contrast to the state of the art cited at the beginning, in which, e.g., separate spacers are in contact with one another. In this way, a space requirement, in particular a construction height, of the holding device can be reduced in comparison with the state of the art.

Due to the holding section and the at least one spacer section being in one piece, additional separate elements, such as separate spacers and associated connection components, can be eliminated. The holding element according to the first aspect enables a holding device with a minimal space requirement, therefore, in particular a minimal construction height. In particular, a holding device with a reduced construction height compared with the state of the art outlined at the beginning is provided. It can also be said that the holding section and the at least one spacer section are integrated or formed integrated with one another. Furthermore, the holding section and the at least one spacer section can be formed of uniform material, i.e., from an identical material. Alternatively, it is also conceivable that the holding section and the at least one spacer section are formed in one piece but are not formed of uniform material. In this case, a one-piece formation can be understood such that the holding section and the at least one spacer section are not separated from one another or provided separately in normal use and/or loading.

The at least two holding elements can also be described as carrier elements, support elements or fastening elements, in order to express that the at least two holding elements are formed to carry, support and/or fasten cables, in particular ribbon cables. The holding device can be described accordingly as carrier device, support device or fastening device. Following the state of the art, the holding device can also be described, for example, as a clamping device and the holding elements as clamping elements. It is conceivable, for example, that the cables to be held, in particular ribbon cables, are arranged between two clamping elements respectively and are clamped by these and held thereby.

According to a possible configuration, each of the at least two holding elements can have precisely two spacer sections. In general, however, any number of spacer sections can be provided per holding element, in particular one, two, three, four or more than four spacer sections. According to one example,—regardless of the precise number of spacer sections—each of the at least two holding elements can have the same number of spacer sections, for example precisely two spacer sections.

The at least two holding elements can be arranged relative to one another such that a receiving space for receiving a cable, in particular a ribbon cable, is created or delimited by respectively two holding elements of the at least two holding elements. The two holding elements can be arranged to form the receiving space such that they substantially form the shape of a hollow cuboid. The cavity of the hollow cuboid can be regarded in this case as a receiving space. The walls of the hollow cuboid can be formed by the holding elements. The shape of a frame can then appear in cross section.

Expressed another way, the receiving space can be understood to mean a cavity or space, which is enclosed circumferentially, for example, by the at least two holding elements and which can have an inlet opening, through which a cable, in particular a ribbon cable, can enter the receiving space, and can have an outlet opening, through which a cable, in particular a ribbon cable, can exit the receiving space. With an angular implementation, the receiving space can be delimited outwardly by a number of, in particular four, walls or faces and can have an opening on two sides respectively through which the cable, in particular the ribbon cable, can be led. The four faces or walls can be formed by two holding sections and two spacer sections. The dimensions of the receiving space can be coordinated to the cable to be received, in particular the ribbon cable to be received. For example, the height of the receiving space can correspond substantially to the height of the cable, in particular of the ribbon cable, so that the cable, in particular the ribbon cable, can be held at least partially by force locking, in particular frictional locking, with the at least two holding elements in the longitudinal direction of the cable, in particular of the ribbon cable, and so that the cable, in particular the ribbon cable, is held in a direction transversely, in particular perpendicularly, to the longitudinal axis of the cable, in particular of the ribbon cable, by a form closure with the at least two holding elements.

According to a first possible exemplary embodiment, the at least two holding elements can be arranged relative to one another such that by two holding elements respectively of the at least two holding elements, a receiving space for receiving a cable, in particular ribbon cable, is created or delimited by: (i) the holding section of a first of the at least two holding elements, (ii) the holding section of a second of the at least two holding elements, (iii) a first spacer section of the at least one spacer section, which extends from the holding section of the first of the at least two holding elements to the holding section of the second of the at least two holding elements, and (iv) a second spacer section of the at least one spacer section, which extends from the holding section of the first of the at least two holding elements to the holding section of the second of the at least two holding elements. In this way, a receiving space is delimited by two spacer sections of the same holding element, namely according to the exemplary counting method of the first holding element. The advantage resulting from this is clear in particular if the two holding elements are stacked with at least one further holding element.

If yet a third holding element is stacked in addition to the two holding elements, a further receiving space is created or delimited by: (i) the holding section of the second of the at least two holding elements, (ii) the holding section of the third of the at least two holding elements, (iii) a first spacer section of the at least one spacer section, which extends from the holding section of the second of the at least two holding elements to the holding section of the third holding element, and (iv) a second spacer section of the at least one spacer section, which extends from the holding section of the second of the at least two holding elements to the holding section of the third holding element.

It becomes clear that using three holding elements, at least two receiving spaces, in said example precisely two receiving spaces, can be formed. This is not achieved in the state of the art. In the state of the art, at least four clamping elements or clamping plates are necessary to form two receiving spaces. This further reduces the space requirement, in particular the construction height, of the holding device compared with the state of the art. Similarly, the addition of further holding elements is possible, wherein a further receiving space is formed by the addition of each further holding element. This also is not achieved in the state of the art.

Expressed differently, the at least two holding elements can have three holding elements or be formed as three holding elements. The three holding elements can be arranged relative to one another along the stack longitudinal axis such that at least two, in particular precisely two, receiving spaces for respectively receiving a cable, in particular a ribbon cable, are created or delimited by the three holding elements. In the state of the art, only one functional clamping space can be formed with three clamping elements or clamping plates. This reduces the necessary space requirement of the holding device compared with the state of the art.

When adding and stacking further holding elements, additional receiving spaces are formed. A single receiving space is not, however, completely delimited, for example. For the final delimitation of this receiving space, an end plate can be used and added to the holding device as part of the holding device. Expressed another way, the holding device can further have an end plate, which is arranged relative to one of the at least two holding elements such that a receiving space is created or delimited by: (i) the holding section of one of the at least two holding elements, (ii) the end plate, (iii) a first spacer section of the at least one spacer section, which extends from the holding section to the end plate, and (iv) a second spacer section of the at least one spacer section, which extends from the holding section to the end plate. A receiving space of the holding device that was not closed previously can be closed by means of the end plate.

Depending on the direction in which the not closed receiving space is formed open, the end plate can be formed as a bottom plate or as a top plate or serve as a bottom plate or as a top plate. It is conceivable, for example, that the holding elements are arranged relative to one another such that a receiving space—looking at the holding device standing on a level surface—is open towards the bottom. In this, the end plate can serve as a bottom plate and delimit the receiving space downwards. Similarly, it is possible that the holding elements are arranged relative to one another such that a receiving space—looking at the holding device standing on a level surface—is open towards the top. In this, the end plate can serve as a top plate and delimit the receiving space upwards. According to a specific configuration, it is possible to delimit each receiving space in the holding device except for a single receiving space by holding sections and the associated spacer sections. The receiving space not delimited hereby can then be delimited by a holding section, the associated spacer sections and the end plate.

The at least two holding elements can be arranged relative to one another such that the at least one spacer section of a first of the at least two holding elements and the at least one spacer section of a second of the at least two holding elements are oriented in a stack direction along the stack longitudinal axis and align with one another. In this case, not only a basic location, but also an orientation is to be understood by the stack direction. Thus the stack direction is placed/arranged along the stack longitudinal axis but furthermore indicates one of two possible orientations. If it is said that two spacer sections are oriented in one stack direction along the stack longitudinal axis, this is to be understood such that both have the same orientation, thus point in the same direction, namely the stack direction, starting out from the associated holding section. Here the stack direction can indicate the direction in which stacking of the holding elements on one another takes place.

At least one spacer section of a holding element can be directly in contact (in direct contact) with the holding section of a directly adjacent holding element in each case. The at least one spacer section of a first of the at least two holding elements and the holding section of a second of the at least two holding elements can be directly in contact with one another in a direction along the stack longitudinal axis, for example. For example, the at least one spacer section of a first of the at least two holding elements and the holding section of a second of the at least two holding elements can be directly in contact with one another in the stack direction. For example, the at least one spacer section of a first of the at least two holding elements can point in the stack direction and in doing so be directly in contact with the holding section of a second of the at least two holding elements.

To connect the at least two holding elements to one another, one or more connection holes can be provided in the at least one spacer section in each case. The one or more connection holes can run along the stack longitudinal axis, for example penetrate the at least one spacer section at least partially in a direction running parallel to the stack longitudinal direction. A detachable connection of the at least two holding elements, for example of all holding elements, can be brought about in that one or more suitable connection elements are introduced into the one or more connection holes or are arranged or received in the one or more connection holes.

According to a second possible exemplary embodiment, the at least two holding elements can be arranged relative to one another such that precisely one receiving space for receiving a cable, in particular a ribbon cable, is created or delimited by two holding elements of the at least two holding elements respectively. The precisely one receiving space, in particular an inner surface of the precisely one receiving space, can be created or delimited by: (i) the holding section of a first of the at least two holding elements, (ii) the holding section of a second of the at least two holding elements, (iii) a spacer section of the at least one spacer section of the first of the at least two holding elements, which extends from the holding section of the first of the at least two holding elements to the holding section of the second of the at least two holding elements, and (iv) a spacer section of the at least one spacer section of the second of the at least two holding elements, which extends from the holding section of the second of the at least two holding elements to the holding section of the first of the at least two holding elements. In contrast to the state of the art cited at the beginning, a receiving space on both flat sides is delimited substantially only by a single spacer section in this way. In contrast to the state of the art, a construction height of the holding device can thereby be reduced, due to which a space requirement for the holding device when in use can be reduced in an advantageous manner.

At least one spacer section of a holding element can be directly in contact (in direct contact) respectively with the holding section of a directly adjacent holding element.

The at least two holding elements can be arranged relative to one another such that the at least one spacer section of a first of the at least two holding elements and the at least one spacer section of a second of the at least two holding elements form with one another a form closure acting transversely to the stack longitudinal axis. For example, the at least two holding elements can be arranged relative to one another such that the at least one spacer section of a first of the at least two holding elements and the at least one spacer section of a second of the at least two holding elements form with one another a form closure acting perpendicularly to the stack longitudinal axis. The form closure has the effect that the holding elements are/become at least partially fixed in a direction transversely, in particular perpendicularly, to the stack longitudinal axis without a mounting of fastening elements. Furthermore, the form closure has the effect that the holding elements can be stacked one on top of the other nested inside one another, so that an overall width of the holding device can be reduced. The space requirement can thereby be reduced, in particular due to the reduced overall width and/or by the reduced construction height. Furthermore, the form closure has the effect that the holding elements can be attached to one another in the region of the form closure. If two spacer sections are provided respectively for each holding element, two form closures can be formed accordingly.

The at least two holding elements can be arranged relative to one another such that the at least one spacer section of a first holding element of the at least two holding elements and the at least one spacer section of a second holding element of the at least two holding elements are arranged offset to one another in a direction transversely, in particular perpendicularly, to the stack longitudinal axis. Due to the offset arrangement of the at least one spacer section of the first holding element and of the at least one spacer section of the second holding element, the aforesaid form closure can be formed in a simple and/or efficient manner.

The at least two holding elements can be arranged relative to one another such that a spacer section of the at least one spacer section of a first of the at least two holding elements and a spacer section of the at least one spacer section of a second of the at least two holding elements can be directly in contact with one another (be in direct contact with one another) in a direction transversely to the stack longitudinal axis. The at least two holding elements can be arranged relative to one another such that a spacer section of the at least one spacer section of a first of the at least two holding elements and a spacer section of the at least one spacer section of a second of the at least two holding elements can be directly in contact with one another (be in direct contact with one another) in a direction perpendicularly to the stack longitudinal axis. This direct contact differs from the state of the art cited at the beginning, in which, if a contact/contacting is present, spacers contact in a region that extends along the stack longitudinal axis. In comparison with this state of the art, this has the effect that the overall width and/or the construction height of the holding device is reduced and thus the space requirement during its use is reduced. It further has the effect that the holding elements can be fastened to one another in the region of the contact/contacting.

A first of the at least two holding elements and a second of the at least two holding elements can be connectable or connected to one another or become attached or be attached to one another via at least one connection hole. The at least one connection hole can penetrate the at least one spacer section of the first of the at least two holding elements and the at least one spacer section of the second of the at least two holding elements in a direction transversely to the stack longitudinal axis. For example, the at least one connection hole can penetrate the at least one spacer section of the first of the at least two holding elements and the at least one spacer section of the second of the at least two holding elements in a direction perpendicularly to the stack longitudinal axis. In the state of the art cited at the beginning, connection elements such as screws are led along the stack longitudinal axis through a number of clamping elements in order to connect the clamping elements to one another. This necessitates a certain additional width in the edge region of the clamping elements, through which the connection elements can be introduced, which in turn reduces the clamping space available in comparison with the overall width. In contrast to this, a necessary width is reduced, if not even rendered at least virtually superfluous, by the connection hole available transversely to the stack longitudinal axis. This leads to a reduced space requirement of the holding device, in particular to a reduced overall width of the holding device. Due to the reduced overall width of the holding device, more installation space can be created for receiving other components in an installation space (or receiving space) in which the holding device can be arranged. Alternatively, the width of the receiving space created by the holding elements can be executed correspondingly smaller and thus material and weight saved.

The present invention is to be explained further on the basis of figures. These figures show schematically:

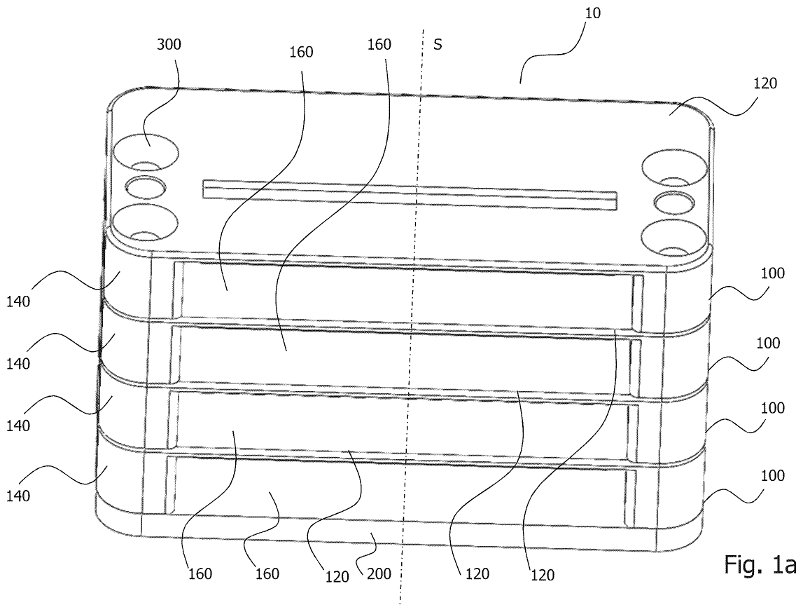

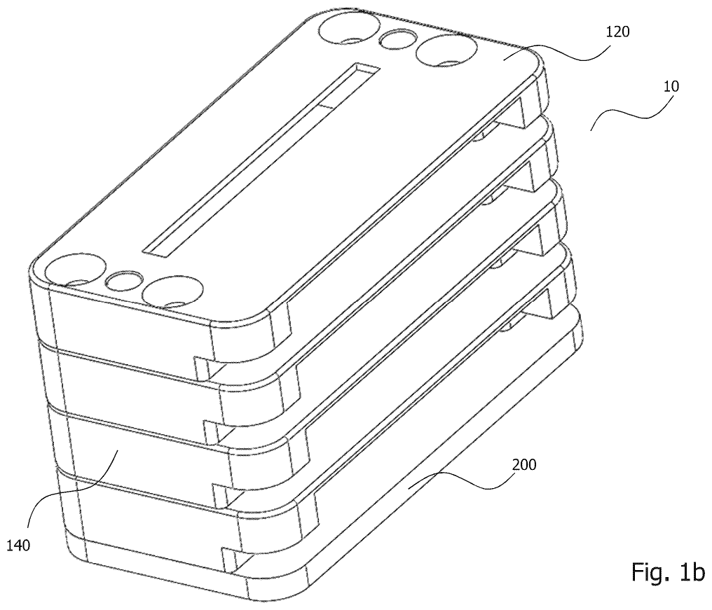

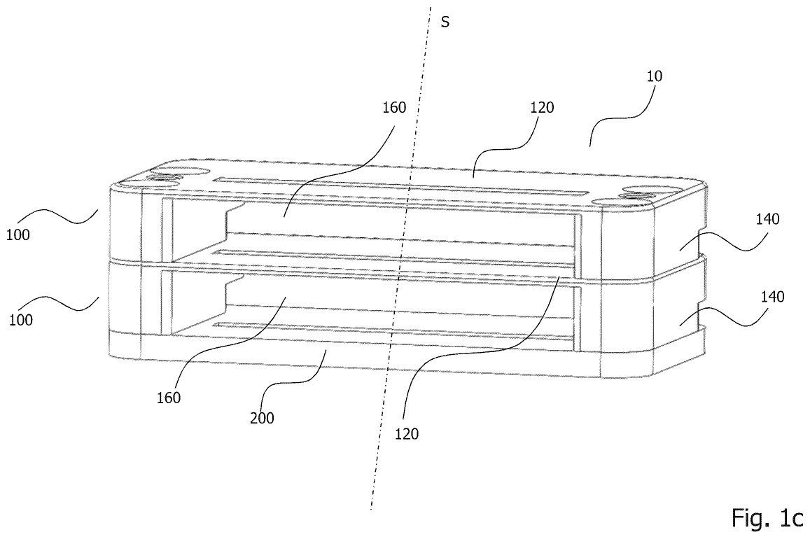

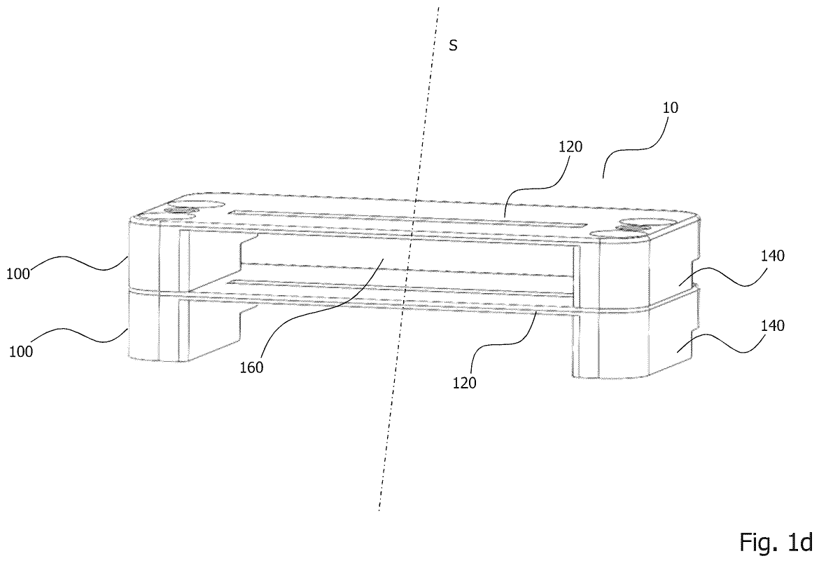

FIG. 1a a first exemplary embodiment of a holding device in a perspective front view;

FIG. 1b the first exemplary embodiment of a holding device from FIG. 1a in a perspective rear view;

FIG. 1c a variant of the first exemplary embodiment of a holding device from FIG. 1a in a perspective front view;

FIG. 1d the variant from FIG. 1c of the first exemplary embodiment of a holding device from FIG. 1a without an end plate in a perspective front view;

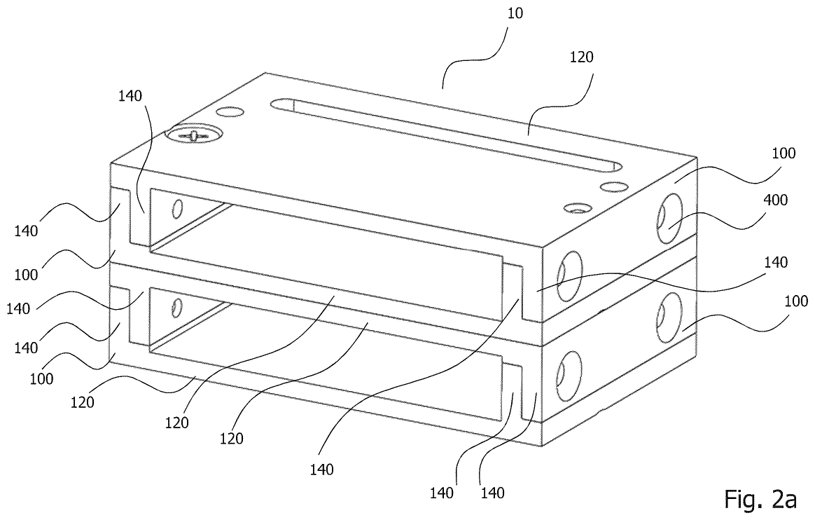

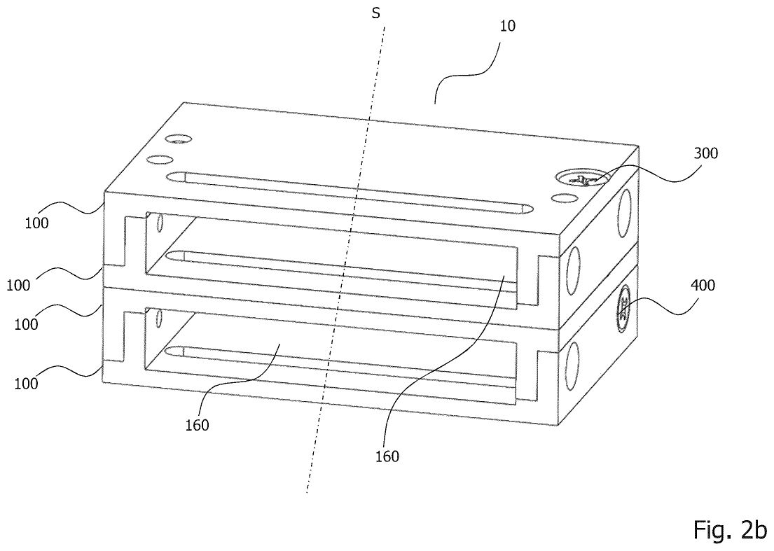

FIG. 2a a second exemplary embodiment of a holding device in a perspective front view; and

FIG. 2b the second exemplary embodiment of a holding device from FIG. 2a in a perspective rear view.

In the following, without being restricted hereto, specific details are set out to provide a complete understanding of the present invention. It is clear to an expert, however, that the present invention can be used in other exemplary embodiments which can diverge from the details set out below. The figures serve further purely for the purpose of clarifying exemplary embodiments. They are not true to scale and are only intended to reflect the general concept of the invention by way of example. For example, features that are contained in the figures should by no means be considered a necessary constituent.

Before going in detail into the two exemplary embodiments depicted schematically in FIGS. 1a to 2b in the following, the common features of the two exemplary embodiments should be sketched briefly first. The first exemplary embodiment is shown in a perspective front view in FIG. 1a and in a perspective rear view in FIG. 1b. The second exemplary embodiment is shown in a perspective front view in FIG. 2a and in a perspective rear view in FIG. 2b.

The holding device 10 according to both exemplary embodiments is a holding device 10 for cables, put more precisely for ribbon cables in the specific exemplary embodiments shown, so that in the following, reference is made principally to ribbon cables as a specific example of cables. The holding device 10 has at least two holding elements 100. Both in the first exemplary embodiment according to FIGS. 1a and 1b and in the second exemplary embodiment according to FIGS. 2a and 2b, the holding device 10 has by way of example precisely four holding elements 100 without being restricted to this exemplary number of holding elements 100. In the variants of the first exemplary embodiment according to FIGS. 1c and 1d, only two holding elements 100 are accordingly provided as an example.

The at least two holding elements 100 of both exemplary embodiments are arranged relative to one another and stacked one on top of the other along a stack longitudinal axis S. Each of the at least two holding elements 100 of both exemplary embodiments have a holding section 120 and at least one spacer section 140. Purely by way of example and without being restricted hereto, precisely two spacer sections 140 are provided for each holding element 100 in both exemplary embodiments. The holding section 120 extends at least substantially transversely, and in both exemplary embodiments shown substantially perpendicularly, to the stack longitudinal axis S. The at least one spacer section 140 extends in a side region of the holding section 120 at least substantially along the stack longitudinal axis S, or, expressed another way, substantially perpendicularly to the holding section 120, from the associated holding section 120. The holding section 120 and the at least one spacer section 140 are formed in one piece with one another.

In the following, the first exemplary embodiment of the holding device 10 according to FIGS. 1a and 1b is described more precisely.

The four holding elements 100 by way of example of the holding device 10 according to the first exemplary embodiment are arranged relative to one another such that a receiving space 160 for receiving a ribbon cable is created or delimited by two holding elements 100 respectively of the altogether four holding elements 100 by way of example. Put more precisely, the four holding elements 100 by way of example are stacked one on top of the other. In the following, the uppermost holding element 100 of the stack is also described as the first or upper holding element 100, the (second uppermost) holding element 100 of the stack placed below it is also described as the second holding element 100, the (third uppermost) holding element 100 of the stack placed below it is also described as the third holding element 100 and the (fourth uppermost=lowest) holding element 100 of the stack placed below it is also described as the fourth or lower holding element 100.

Each receiving space 160 is delimited in each case by a holding section 120 of a holding element 100, a holding section 120 of a holding element 100 lying directly underneath it, a first spacer section 140, which extends from the holding section 120 of the holding element 100 to the holding section 120 of the holding element 100 lying directly underneath it, and a second spacer section 140, which extends from the holding section 120 of the holding element 100 to the holding section 120 of the holding element 100 lying directly underneath it.

In the specific case of the four receiving spaces 160 of the holding device 10 according to the first exemplary embodiment that are shown in FIGS. 1a and 1b, the uppermost receiving space 160 is delimited by the holding section 120 of the uppermost holding element 100, the holding section 120 of the second uppermost holding element 100, a first spacer section 140, which extends from the holding section 120 of the uppermost holding element 100 to the holding section 120 of the second uppermost holding element 100, and a second spacer section 140, which extends from the holding section 120 of the uppermost holding element 100 to the holding section 120 of the second uppermost holding element 100. The second uppermost receiving space 160 is delimited by the holding section 120 of the second uppermost holding element 100, the holding section 120 of the third uppermost holding element 100, a first spacer section 140, which extends from the holding section 120 of the second uppermost holding element 100 to the holding section 140 of the third uppermost holding element 100, and a second spacer section 140, which extends from the holding section 120 of the second uppermost holding element 100 to the holding section 120 of the third uppermost holding element 100. The same applies to the third uppermost receiving space 160.

By contrast, the lowest receiving space 160 is formed differently, namely with an end plate 200. The end plate 200 is arranged relative to the lowest holding element 100 such that a lowest receiving space 160 is created or delimited by the holding section 120 of the lowest holding element 100, the end plate 200, a first spacer section 140, which extends from the lowest holding section 120 to the end plate 200, and a second spacer section 140, which extends from the lowest holding section 120 to the end plate 200.

As is to be recognized in FIGS. 1a and 1b, the four holding elements 100 by way of example are arranged relative to one another such that their respective exemplary two spacer sections 130 are oriented along the stack longitudinal axis S and align with one another. Moreover, it is to be recognized that the spacer sections 130 not only run along the stack longitudinal axis S, but at the same time always have the same orientation, i.e., always point/are oriented in the same direction. In the exemplary embodiment shown, this direction runs downwards along the stack longitudinal axis S and is termed the stack direction, as a stack process takes place downwards in that a top holding element 100 is led downwards to be stacked upon a lower holding element 100.

Furthermore, the spacer sections 140 of a holding element 100 are directly in contact (in direct contact) in each case with the holding section 120 of a holding element 100 lying directly underneath. For the example shown, this means that the spacer sections 140 of the uppermost holding element 100 are each in direct contact with the holding section 120 of the second uppermost holding element 100. Furthermore, the spacer sections 140 of the second uppermost holding element 100 are each directly in contact (in direct contact) with the holding section 120 of the third uppermost holding element 100. The spacer sections 140 of the lowest holding element 100 are each directly in contact (in direct contact) with the end plate 200. In this sense, not only the free section, which is directly in contact with the ribbon cable in the case of a ribbon cable received in the associated receiving space 160, but the entire part of the respective holding element 100 extending substantially transversely, in particular perpendicularly, to the stack longitudinal axis S can be understood as a holding section 120 of the respective holding elements 100. Expressed differently, a spacer section 140 of a respective holding element 100 extends, for instance, starting out from a side region of a holding element 100, which is possibly not directly in contact with the ribbon cable, to a side region of a holding section 120 of a holding element 100 lying directly underneath, which is possibly not directly in contact with the ribbon cable. These side regions can nonetheless be regarded as part of the respective holding section 120. In the first exemplary embodiment, therefore, the two spacer sections 140 of a holding element 100 are directly in contact with a holding section 120 of a holding element 100 lying directly underneath.

As is to be recognized in FIGS. 1a and 1b, among other things it is achieved thereby that a lower delimitation of a receiving space 160 serves at the same time as upper delimitation of a receiving space 160 lying directly underneath. The construction height of the holding device 10 is reduced/minimized in this way. This means that the lower delimitation of the uppermost receiving space 160 is the holding section 120 of the second uppermost holding element 100. The holding section 120 of the second uppermost holding element 100 serves at the same time also as upper delimitation of the second uppermost receiving space 160. For the lowest receiving space 160, however, no holding section 120 of a holding element 100 is used in the example shown, but the end plate 200. Due to the orientation, configuration and arrangement of the holding elements 100, therefore, the space requirement of the holding device 10 is reduced/minimized.

To connect two or more, for example all, holding elements 100, additional connection holes 300 can optionally be provided, in which suitable connection elements can be received in order to connect two or more holding elements 100 to one another. The connection holes 300 can extend, as shown by way of example with reference to FIGS. 1a and 1b, parallel to the stack longitudinal axis S through the respective spacer sections 140. The end plate 200 also can be provided with corresponding connection holes 300.

In FIG. 1c, a variant of the first exemplary embodiment of the holding device from FIGS. 1a and 1b is shown. In FIG. 1c, the holding device 10 is to be seen in a front view. The holding device 10 from FIG. 1c differs from the holding device 10 from FIGS. 1a and 1b in that only two holding elements 100 are provided, put more precisely are arranged one on top of the other. This means that the holding device 10 from FIG. 1c has two holding elements 100. Each of the holding elements 100 has a holding section 120 and two spacer sections 140, as was described with reference to FIGS. 1a and 1b. The spacer sections 140 of the upper holding element 100 are directly in contact with the holding section 120 of the lower holding element 100. The holding section 120 of the upper holding element 100, the two spacer sections 140 of the upper holding element 100 and the holding section of the lower holding element 120 delimit an upper receiving space 160. A lower receiving space 160 is delimited by the holding section 120 of the upper holding element 100, the two spacer sections 140 of the upper holding element 100 and an end plate 200, as likewise described with reference to FIGS. 1a and 1b. The variant shown in FIG. 1c illustrates that two receiving spaces 160 can already be created with two holding elements 100.

In FIG. 1d, the variant of the holding device 10 from FIG. 1c is shown without an end plate 200. This depiction illustrates that even without an end plate, a receiving space 160 can be formed with two holding elements 100 and correspondingly a further receiving space 160 can be formed by a further holding element 100 on addition.

In the following, the second exemplary embodiment of the holding device 10 according to FIGS. 2a and 2b is described more precisely.

The four holding elements 100 by way of example of the holding device 10 according to the second exemplary embodiment are arranged relative to one another such that precisely one receiving space 160 for receiving a ribbon cable is created or delimited respectively by two holding elements 100. The precisely one receiving space 160, in particular an inner surface of the precisely one receiving space 160, is created or delimited in each case by: a holding section 120 of a holding element 100, a holding section 120 of a holding element 100 lying directly underneath, a spacer section 140 of the holding element 100, which extends from the holding section of the holding element 100 to the holding section 120 of the holding element 100 lying directly underneath, and a spacer section 140 of the holding element 100 lying directly underneath, which extends from the holding section 120 of the holding element 100 lying directly underneath to the holding section 120 of the holding element 100.

This means that the uppermost receiving space 160, in particular the inner surface of the uppermost receiving space 160, is created or delimited by: the holding section 120 of the uppermost holding element 100, the holding section 120 of the second uppermost holding element 100, a spacer section 140 of the uppermost holding element 100, which extends from the holding section 120 of the uppermost holding element 100 to the holding section 120 of the second uppermost holding element 100, and a spacer section 140 of the second uppermost holding element 100, which extends from the holding section 120 of the second uppermost holding element 100 to the holding section 120 of the uppermost holding element 100. The second upper-most (=lowest) receiving space 160, in particular the inner surface of the second uppermost (=lowest) receiving space 160, is created or delimited by: the holding section 120 of the third uppermost holding element 100, the holding section 120 of the fourth uppermost (=lowest) holding element 100, a spacer section 140 of the third uppermost holding element, which extends from the holding section 120 of the third uppermost holding element 100 to the holding section 120 of the fourth upper-most (=lowest) holding element 100, and a spacer section 140 of the fourth upper-most (=lowest) holding element 100, which extends from the holding section 120 of the fourth uppermost (=lowest) holding element 100 to the holding section 120 of the third uppermost holding element 100.

Furthermore, as described with reference to the first exemplary embodiment from FIGS. 1a and 1b, at least one spacer section 140 of a holding element 100 is directly in contact (in direct contact) in each case with the holding section 120 of a directly adjacent holding element 100. This means for the example shown in FIGS. 2a and 2b that, e.g., the left spacer section 140 of the uppermost holding element 100 in FIG. 2a is directly in contact (in direct contact) with the holding section 120 of the second uppermost holding element 100. Furthermore, the right spacer section 140 of the second uppermost holding element 100 in FIG. 2a is directly in contact (in direct contact) with the holding section 120 of the uppermost holding element 100. Moreover, the left spacer section 140 of the third uppermost holding element 100 in FIG. 2a is directly in contact (in direct contact) with the holding section 120 of the fourth uppermost (=lowest) holding element 100. Furthermore, the right spacer section 140 of the fourth uppermost (=lowest) holding element 100 in FIG. 2a is directly in contact (in direct contact) with the holding section 120 of the third uppermost holding element 100. In this sense, not only the free section, which is directly in contact with the ribbon cable in the case of a ribbon cable received in the associated receiving space 160, but the entire part of the respective holding element 100 extending substantially transversely, in particular perpendicularly, to the stack longitudinal axis S can be understood as a holding section 120 of the respective holding elements 100. Expressed differently, a spacer section 140 of a respective holding element 100 extends as an example starting out from a side region of a holding element 100, which is not necessarily directly in contact with the ribbon cable, to a side region of a holding section 120 of a directly adjacent holding element 100, for example lying underneath or above it, which is not necessarily directly in contact with the ribbon cable. These side regions can nonetheless be regarded as part of the respective holding section 120. In the second exemplary embodiment, therefore, at least one of the two spacer sections 140, in particular the two spacer sections 140, of a holding element 100 is directly in contact with a holding section 120 of a directly adjacent holding element 100, for example lying directly underneath or above it.

As is to be recognized in FIGS. 2a and 2b, the spacer sections 140 are arranged partially offset to one another in the direction transversely, and in FIGS. 2a and 2b put more precisely perpendicularly, to the stack longitudinal axis S. This offset is achieved due to the fact that, although the holding elements 100 correspond exactly, they are arranged rotated alternately relative to one another (about an axis perpendicular to the stack longitudinal axis S). When counting from top to bottom, the even-numbered holding elements 100 are arranged rotated relative to the odd-numbered holding elements 100 in the stack. With reference to FIG. 2a, this means that the right spacer section 140 runs downwards further out from the holding section 120 of the uppermost holding element 100 than the right spacer section 140 of the holding element 100 lying directly underneath, which runs upwards situated further in from the holding section 120. Correspondingly, the left spacer section 140 runs downwards further in from the holding section 120 of the uppermost holding element 100 than the left spacer section 140 of the holding element 100 lying directly underneath, which runs upwards situated further out from the holding section 120.

In this way, a form closure acting transversely, in particular perpendicularly, to the stack longitudinal axis S is formed, to be precise on the left side of the uppermost holding element 100 and the holding element 100 lying directly underneath, by the left spacer section 140 of the uppermost holding element 100 and the left spacer section 140 of the holding element 100 lying directly underneath. Furthermore, a form closure acting transversely, in particular perpendicularly, to the stack longitudinal axis S is formed, to be precise on the right side of the uppermost holding element 100 and the holding element 100 lying directly underneath, by the right spacer section 140 of the uppermost holding element 100 and the right spacer section 140 of the holding element 100 lying directly underneath. The form closure prevents displacement of the holding elements 100 transversely, in particular perpendicularly, to the stack longitudinal axis S at least in one direction and permits nesting of the holding elements 100 inside one another.

The respective form closure further leads to the spacer sections 140 respectively forming the form closure being in direct contact with one another in a direction transversely, in particular perpendicularly, to the stack longitudinal axis S. Put more precisely, with reference to FIG. 2a, the inside of the left spacer section 140 of the second uppermost holding element 100 and the outside of the left spacer section 140 of the uppermost holding element 100 are directly in contact (in direct contact) with one another on the left side. Furthermore, on the right side, the outside of the right spacer section of the second uppermost holding element 100 and the inside of the right spacer section 140 of the uppermost holding element 100 are directly in contact (in direct contact) with one another.

The direct contact has the effect that in the overlapping region, the holding elements can be connected to one another. For this purpose, two connection holes 400 are provided respectively in the overlapping regions in the example from FIGS. 2a and 2b, which holes penetrate the respective spacer sections 140 in a direction transversely, in particular perpendicularly, to the stack direction S. Put more precisely, two connection holes 400 are provided, which penetrate the right spacer section 140 of the uppermost holding element 100 and the right spacer section 140 of the holding element 100 lying directly underneath. Furthermore, two connection holes 400 are provided, which penetrate the left spacer section 140 of the uppermost holding element 100 and the left spacer section 140 of the holding element 100 lying directly underneath (to be seen in FIG. 2b). Two holding elements 100 can then be connected to one another in each case via connection elements, e.g., screws, introduced into the connection holes 400. Pairs of holding elements 100 can be formed by way of this connection of two holding elements 100 via the connection holes. To connect these pairs of holding elements 100, additional connection holes 300 can optionally be provided, in which suitable connection elements can be received in order to connect two or more such pairs to one another.

As is to be recognized in FIGS. 2a and 2b, it is achieved by the connection holes 400 that two holding elements 100 in each case can be connected to one another transversely, in particular perpendicularly, to the stack longitudinal axis S. This reduces an overall width of the holding device 100, as no regions have to be provided via which a connection takes place along the stack longitudinal axis. Furthermore, a construction height of the holding device 10 is reduced/minimized by way of the nested arrangement of the holding elements 100 relative to one another. Due to the orientation, configuration and arrangement of the holding elements 100, therefore, the space requirement of the holding device 10 is reduced/minimized.

1. A holding device for cables, in particular ribbon cables, wherein the holding device has at least two holding elements, wherein the at least two holding elements are arranged relative to one another and stacked one on top of the other along a stack longitudinal axis and wherein each of the at least two holding elements has:
a holding section that extends at least substantially transversely, in particular perpendicularly, to the stack longitudinal axis; and
at least one spacer section that extends from the holding section in a side region of the holding section at least substantially along the stack longitudinal axis;
wherein the holding section and the at least one spacer section are formed in one piece with one another and wherein the at least two holding elements are arranged relative to one another such that the at least one spacer section of a first of the at least two holding elements and the holding section of a second of the at least two holding elements are directly in contact with one another.

2. The holding device according to claim 1, wherein each of the at least two holding elements has precisely two spacer sections.

3. The holding device according to claim 1, wherein the at least two holding elements are arranged relative to one another such that a receiving space for receiving a cable, in particular a ribbon cable, is delimited respectively by two holding elements by:
the holding section of a first of the at least two holding elements,
the holding section of a second of the at least two holding elements,
a first spacer section which extends from the holding section of the first of the at least two holding elements to the holding section of the second of the at least two holding elements, and a second spacer section, which extends from the holding section of the first of the at least two holding elements to the holding section of the second of the at least two holding elements.

4. The holding device according to claim 1, wherein the holding device further has an end plate, which is arranged relative to one of the at least two holding elements such that a receiving space is delimited by:
the holding section of one of the at least two holding elements,
the end plate,
a first spacer section, which extends from the holding section to the end plate, and
a second spacer section, which extends from the holding section to the end plate.

5. The holding device according to claim 1, wherein the at least two holding elements have three holding elements, which are arranged relative to one another such that at least two, in particular precisely two, receiving spaces for respectively receiving a cable, in particular a ribbon cable, are delimited by the three holding elements.

6. The holding device according to claim 1, wherein the at least two holding elements are arranged relative to one another such that the at least one spacer section of a first of the at least two holding elements and the at least one spacer section of a second of the at least two holding elements are oriented in a stack direction along the stack longitudinal axis and align with one another.

7. The holding device according to claim 1, wherein the at least one spacer section of a first of the at least two holding elements and the holding section of a second of the at least two holding elements are directly in contact with one another in a direction along the stack longitudinal axis, in particular in the stack direction.

8. The holding device according to claim 1, wherein the at least two holding elements are arranged relative to one another such that precisely one receiving space for receiving a cable, in particular a ribbon cable, is delimited by two holding elements respectively, wherein the precisely one receiving space, in particular an inner surface of the precisely one receiving space, is delimited by:
the holding section of a first of the at least two holding elements,
the holding section of a second of the at least two holding elements,
a spacer section of the first of the at least two holding elements, which extends from the holding section of the first of the at least two holding elements to the holding section of the second of the at least two holding elements, and
a spacer section of the second of the at least two holding elements, which extends from the holding section of the second of the at least two holding elements to the holding section of the first of the at least two holding elements.

9. The holding device according to claim 1, wherein the at least two holding elements are arranged relative to one another such that the at least one spacer section of a first of the at least two holding elements and the at least one spacer section of a second of the at least two holding elements form with one another a form closure acting transversely, in particular perpendicularly, to the stack longitudinal axis.

10. The holding device according to claim 1, wherein the at least two holding elements are arranged relative to one another such that the at least one spacer section of a first holding element of the at least two holding elements and the at least one spacer section of a second holding element of the at least two holding elements are arranged offset to one another in a direction transversely, in particular perpendicularly, to the stack longitudinal axis.

11. The holding device according to claim 1, wherein the at least two holding elements are arranged relative to one another such that a spacer section of a first of the at least two holding elements and a spacer section of a second of the at least two holding elements are directly in contact with one another in a direction transversely, in particular perpendicularly, to the stack longitudinal axis.

12. The holding device according to claim 1, wherein a first of the at least two holding elements (100) and a second of the at least two holding elements are connectable or connected to one another via at least one connection hole, which penetrates the at least one spacer section of the first of the at least two holding elements and the at least one spacer section of the second of the at least two holding elements in a direction transversely, in particular perpendicularly, to the stack longitudinal axis.
